(19) United States
(12) Patent Application Publication
(10) Pub. No.: US 2023/0151184 A1
(43) Pub. Date: May 18, 2023

(54) RUBBER COMPOSITION AND METHOD FOR PRODUCING THE SAME

(71) Applicant: Toyo Tire Corporation, Itami-shi (JP)

(72) Inventor: Hironori Miyazaki, Itami-shi (JP)

(73) Assignee: Toyo Tire Corporation, Itami-shi (JP)

(21) Appl. No.: 17/978,583

(22) Filed: Nov. 1, 2022

(30) Foreign Application Priority Data
Nov. 17, 2021 (JP) 2021-187379

(51) Int. Cl. C08K 5/315; C08K 7/02; B60C 1/00

(52) U.S. Cl. CPC C08K 5/315; C08K 7/02; B60C 1/0016

(57) ABSTRACT

To provide a composition excellent in self-healing ability, and to provide a method for producing the composition. The composition contains a diene-based rubber, an anthracene compound having at least one substituent selected from the group consisting of a nitrile oxide group, an azido group, and a thiol group, the anthracene compound being incorporated into the diene-based rubber, and a crosslinking agent having two or more dienophile structures.

### BACKGROUND OF THE INVENTION

### 1. Field of the Invention

The present invention relates to a rubber composition and a method for producing the same.

### 2. Description of the Related Art

In recent years, a material having self-healing ability has been demanded from the viewpoint of environmental harmony. For example, JP-A-2014-34615 (Patent Literature 1) describes a thermoplastic elastomer having a crosslinked structure capable of reversibly proceeding with crosslinking and decrosslinking depending on temperature. In this thermoplastic elastomer, a conjugated diene structure bonded to the main chain via an amino group and a crosslinking agent having two or more dienophile structures form a crosslinked structure by a Diels-Alder reaction.

However, there is room for improvement in self-healing ability. Further, Patent Literature 1 does not describe the use of an anthracene compound as a conjugated diene structure.

### SUMMARY OF THE INVENTION

In view of the above, an object of the present invention is to provide a rubber composition excellent in self-healing ability and a method for producing the same.

JP-A-2017-110192 (Patent Literature 2) describes a relocatable hot melt adhesive using a Diels-Alder reaction. However, this invention relates to an adhesive, and is not applied to tires. Further, it is different from the present invention in that the anthracene compound is introduced into the main chain of the thermoplastic elastomer by copolymerization.

Japanese Patent No. 5558264 (Patent Literature 3) describes that a polymer material having a glycidyl group or an ethoxycarbonyl group introduced therein is obtained by using a compound having a nitrile oxide group. Further, Patent Literature 3 describes that a crosslinked structure is obtained by reacting the obtained polymer material with a diamine compound or a dihydrazide compound. However, the crosslinking reaction obtained by these substituents is irreversible and does not have self-healing ability.

A rubber composition according to the present invention contains a diene-based rubber; an anthracene compound having at least one substituent selected from the group consisting of a nitrile oxide group, an azide group, and a thiol group, the anthracene compound being incorporated into the diene-based rubber; and a crosslinking agent having two or more dienophile structures.

The crosslinking agent may be a bismaleimide compound.

The anthracene compound may be anthracene-9-carbonitrile oxide.

The crosslinked rubber according to the present invention is obtained by heating the above-mentioned rubber composition.

A method for producing a rubber composition according to the present invention includes: a first step of mixing a diene-based rubber with an anthracene compound having at least one substituent selected from the group consisting of a nitrile oxide group, an azide group, and a thiol group; a second step of mixing the composition obtained in the first step with a reinforcing filler; and a third step of mixing the composition obtained in the second step with a crosslinking agent having two or more dienophile structures.

According to the rubber composition of the present invention, self-healing ability can be obtained.

### DESCRIPTION OF EMBODIMENTS

Hereinafter, matters related to the implementation of the present invention will be described in detail.

The rubber composition according to the present embodiment contains a diene-based rubber; an anthracene compound having at least one substituent selected from the group consisting of a nitrile oxide group, an azide group, and a thiol group, the anthracene compound being incorporated into the diene-based rubber; and a crosslinking agent having two or more dienophile structures.

The rubber composition according to the present embodiment contains a diene-based rubber as a rubber component, and the type thereof is not particularly limited, but examples thereof include natural rubber (NR), isoprene rubber (IR), butadiene rubber (BR), styrene-butadiene rubber (SBR), styrene-isoprene copolymer rubber, butadiene-isoprene copolymer rubber, styrene-isoprene-butadiene copolymer rubber, acrylonitrile butadiene rubber (NBR), chloroprene rubber (CR), and butyl rubber (IIR).

The anthracene compound according to the present embodiment has at least one selected from the group consisting of a nitrile oxide group, an azide group, and a thiol group as a substituent. Among these substituents, a nitrile oxide group is preferable. By the substitution carrying out a click reaction or a thiol-ene reaction with respect to a carbon-carbon double bond of a diene-based rubber as shown in the following reaction formula, the anthracene compound can be incorporated into the diene-based rubber. The anthracene compound may further have a substituent other than the above-described substituents as long as the Diels-Alder reaction described later is not affected.

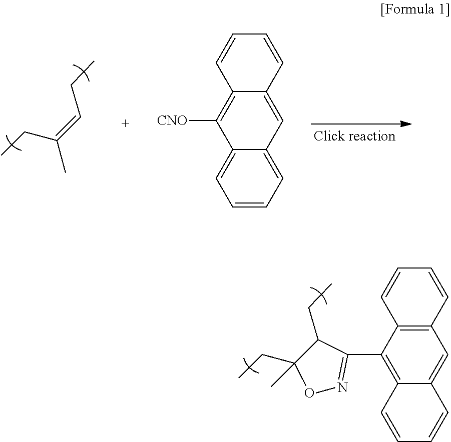

The crosslinking agent according to the present embodiment is not particularly limited as long as it has two or more dienophile structures. Examples of the compound having a dienophile structure include maleimide, N-(4-aminophenyl)maleimide, and maleic acid monoamide. Examples of the crosslinking agent having two or more dienophile structures include bis(3-ethyl-5-methyl-4-maleimidophenyl) methane, 4,4′-bismaleimide diphenylmethane, 1,2-bis(maleimide)ethane, 1,6-bis(maleimide)hexane, N,N′-1,3-phenylene bismaleimide, and N,N′-1,4-phenylene bismaleimide.

As shown in the following reaction formula, the rubber composition according to the present embodiment is configured such that an anthracene compound incorporated into a diene-based rubber and a crosslinking agent having two or more dienophile structures (bismaleimide in the following reaction formula) cause a Diels-Aider reaction to form a crosslinked structure, and the crosslinked structure reversibly proceeds with crosslinking and decrosslinking depending on temperature.

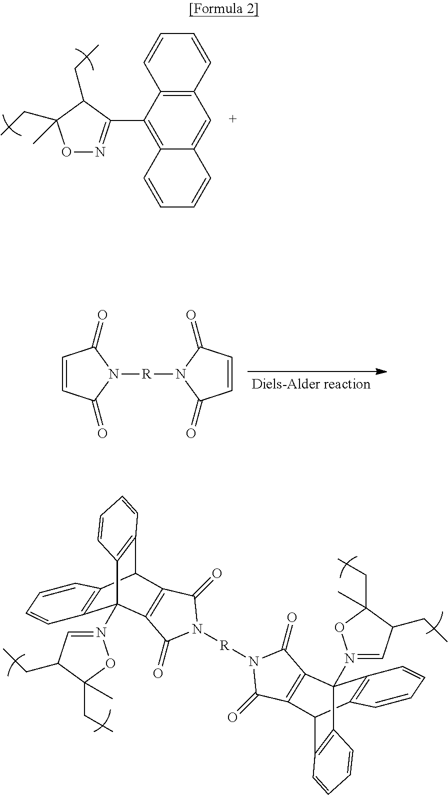

The content of the anthracene compound is not particularly limited, but is preferably 0.1 to 30 parts by mass, more preferably 1 to 20 parts by mass, and still more preferably 1 to 10 parts by mass with respect to 100 parts by mass of the diene-based rubber.

The content of the crosslinking agent; having two or more dienophile structures is not particularly limited, but is preferably 0.1 to 20 parts by mass, more preferably 1 to 10 parts by mass, and still more preferably 1 to 5 parts by mass with respect to 100 parts by mass of the diene-based rubber.

The content ratio of the anthracene compound and the crosslinking agent (anthracene compound/crosslinking agent) is not particularly limited, but is preferably 1 to 50, more preferably 1 to 40, and still more preferably 1 to 30. When the proportion of the anthracene compound is greater than that of the crosslinking agent, the dienophile structure of the decrosslinked crosslinking agent is easily recrosslinked with anthracene.

In the rubber composition according to the present embodiment, in addition to the above-described components, compounding chemicals such as reinforcing filler, process oil, softening agent, plasticizer, wax, aging inhibitor, sulfur, and vulcanization accelerator, which are used in the ordinary rubber industry, can be appropriately blended within a normal range.

As the reinforcing filler, it is preferable to use carbon black and/or silica. That is, the reinforcing filler may be carbon black alone, silica alone, or a combination of carbon black and silica. Preferably, carbon black alone or a combination of carbon black and silica is used. The content of the reinforcing filler is not particularly limited, and is, for example, preferably 10 to 140 parts by mass, more preferably 20 to 100 parts by mass, and still more preferably 30 to 80 parts by mass with respect to 100 parts by mass of the diene-based rubber.

The carbon black is not particularly limited, and various known types can be used. The content of the carbon black is preferably 5 to 100 parts by mass, and more preferably 20 to 80 parts by mass with respect to 100 parts by mass of the diene-based rubber.

The silica is also not particularly limited, but wet silica such as wet precipitated silica and wet gel method silica is preferably used. When silica is blended, the content thereof is preferably 5 to 40 parts by mass, and more preferably 5 to 30 parts by mass with respect to 100 parts by mass of the diene-based rubber.

The rubber composition according to the present embodiment can be produced, for example, by the following method using a generally used mixing machine such as a Banbury mixer, a kneader, or a roll.

First, as a first step, a diene-based rubber is mixed with an anthracene compound having at least one substituent selected from the group consisting of a nitrile oxide group, an azide group, and a thiol group. By mixing the diene-based rubber and the anthracene compound, a click reaction occurs, and the anthracene compound is incorporated into the diene-based rubber. At this time, from the viewpoint of dispersibility of the anthracene compound and reactivity with the diene-based rubber, for example, kneading can be performed at 100° C. or higher for 30 seconds or more.

As a second step, a reinforcing filler can be mixed with the composition obtained in the first step. At this time, from the viewpoint of dispersibility of the compounding agent, for example, kneading can be performed at 100° C. or higher for 1 minute or more.

As a third step, a crosslinking agent having two or more dienophile structures can be kneaded with the composition obtained in the second step. At this time, for example, kneading can be performed at 50° C. or higher for 30 seconds or more.

By heating the rubber composition obtained in the third step at 140 to 170° C. to cause a Diels-Alder reaction between the anthracene compound and the crosslinking agent having two or more dienophile structures, a crosslinked structure is formed and a crosslinked rubber can be obtained.

The rubber composition thus obtained can be applied to various parts of tires such as treads and sidewalls of pneumatic tires of various applications and various sizes such as tires for passenger cars and large tires for trucks and buses. That is, the rubber composition is molded into a predetermined shape by an ordinary method, for example, extrusion processing, combined with other components to produce a green tire, and then the green tire is vulcanization-molded at, for example, 140° C. to 180° C., whereby a pneumatic tire can be produced. Among these, it is particularly preferable to use the rubber composition as a formulation for treads of tires.

### EXAMPLES

Examples of the present invention will be described below, but the present invention is not limited to these examples.

In Comparative Example 1, a rubber composition was prepared using a Banbury mixer according to the mix proportion (parts by mass) shown in Table 1 below by first adding and mixing the components except for sulfur and a vulcanization accelerator in a first mixing stage (discharge temperature=160° C.), and then adding and mixing the sulfur and the vulcanization accelerator to the resulting mixture in a second mixing stage (discharge temperature=90° C.).

In Comparative Example 2, a rubber composition was prepared using a Banbury mixer according to the mix proportion (parts by mass) shown in Table 1 below by first adding isoprene rubber and an anthracene compound in a first mixing stage, kneading at 100° C. or higher for 30 seconds or more, and then adding and mixing carbon black in a second mixing stage (discharge temperature=160° C.).

In Comparative Example 3, a rubber composition was prepared using a Banbury mixer according to the mix proportion (parts by mass) shown in Table 1 below by first adding and mixing isoprene rubber and carbon black (discharge temperature=160° C.) in a first mixing stage and then adding and mixing a crosslinking agent to the resulting mixture in a second mixing stage (discharge temperature=90° C.).

In Example 1, a rubber composition was prepared using a Banbury mixer according to the mix proportion (parts by mass) shown in Table 1 below by first adding isoprene rubber and an anthracene compound and kneading at 100° C. or higher for 30 seconds or more in a first mixing stage, then adding and mixing carbon black in a second mixing stage (discharge temperature=160° C.), and then adding and mixing a crosslinking agent to the resulting mixture in a third mixing stage (discharge temperature=90° C.).

### SYNTHESIS EXAMPLE

Under a nitrogen atmosphere, 90 mL of THF, 10 mL of water, 2.1 g (10 mmol) of 9-anthracenecarboxyaldehyde, 1.6 g (20 mmol) of sodium acetate, and 1.4 g (20 mmol) of hydroxylamine hydrochloride were added, and the mixture was stirred at room temperature for 5 hours. After completion of the reaction, water was added to the reaction solution, and the mixture was extracted three times with ethyl acetate. The obtained organic layer was washed with saturated brine, dehydrated with anhydrous magnesium sulfate, filtered, and concentrated under reduced pressure. 2.2 g (yield 99%) of Compound A was obtained.

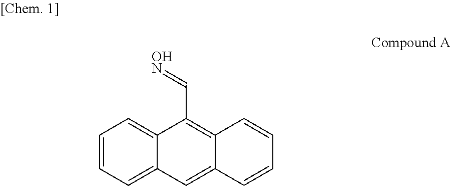

Under a nitrogen atmosphere, 200 mL of dichloromethane, 2.2 g (10 mmol) of Compound A, 1.5 g (15 mmol) of triethylamine, and 1.5 g (11 mmol) of N-chlorosuccinimide were added, and the mixture was stirred at room temperature for 1 hour. After completion of the reaction, water was added to the reaction solution, and the mixture was extracted three times with dichloromethane. The obtained organic layer was washed with saturated brine, dehydrated with anhydrous magnesium sulfate, filtered, and concentrated under reduced pressure. 2.1 g (yield 94%) of Compound B was obtained.

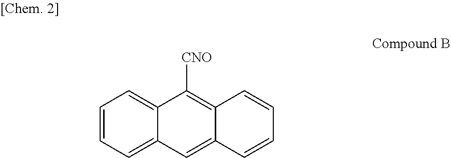

The details of each component in Table 1 are as follows.
Isoprene rubber: “IR2200” manufactured by JSR Corporation
Carbon black: “SHOWBLACK N330T” manufactured by Cabot Japan K.K.
Zinc oxide: “Zinc Oxide Type III” manufactured by Mitsui Mining & Smelting Co., Ltd.
Stearic acid: “Lunac S-20” manufactured by Kao Corporation
Sulfur: “Powdered sulfur” manufactured by Tsurumi Chemical Industry Co., Ltd.
Vulcanization accelerator: “Nocceler CZ-G”, manufactured by Ouchi Shinko Chemical Industrial Co., Ltd.
Anthracene Compound: Compound B (anthracene-9-carbonitrile oxide) obtained in the above Synthesis Example
Crosslinking agent: “Vulnoc PM” manufactured by Ouchi Shinko Chemical Industrial Co., Ltd., N,N′-1,3-phenylene bismaleimide

Each of the obtained rubber compositions was vulcanized under pressure at 160° C. using a metallic plate as a mold to prepare a vulcanized rubber sample. As the vulcanization time, 90% vulcanization time described in JIS K6300-2 was applied.

Crosslinkability: After the obtained sample 200 mg was immersed in 50 to 100 mL of toluene for 2 days, the weight of the dried sample was measured. A sample having a weight change rate of 40% or less was evaluated as having excellent crosslinkability, and indicated as “Good” in Table 1.

Self-healing ability: A sample having a 1 mm thickness was cut with scissors, and heated at 80° C. for 1 day in a state where the cut surfaces were put together. Whether or not the sample was stuck was observed by lifting the sample, and the sample stuck was evaluated as excellent in self-healing ability and indicated as “Good” in Table 1.

TABLE 1

| | Comparative | Comparative | Comparative | |
|---|---|---|---|---|
| | Example 1 | Example 2 | Example 3 | Example 1 |
| Isoprene rubber | 100 | 100 | 100 | 100 |
| Carbon black | 30 | 30 | 30 | 30 |
| Zinc oxide | 2 | — | — | — |
| Stearic acid | 1 | — | — | — |
| Sulfur | 2.5 | — | — | — |
| Vulcanization | 1 | — | — | — |
| accelerator | | | | |
| Anthracene | — | 3 | — | 3 |
| compound | | | | |
| Crosslinking | — | — | 2 | 2 |
| agent | | | | |
| Crosslinkability | Good | NG | Good | Good |
| Self-healing | NG | — | NG | Good |
| ability | | | | |

The results are as shown in Table 1, and Comparative Example 2 is an example in which an anthracene compound was blended but a crosslinking agent was not blended, but sufficient crosslinking was not obtained, and the self-healing ability could not be evaluated.

Comparative Example 3 is an example in which an anthracene compound was not blended and a crosslinking agent was blended, but the self healing ability could not be obtained.

On the other hand, in Example 1, excellent self-healing ability was obtained by blending an anthracene compound and a crosslinking agent.

The rubber composition of the present invention can be used for a tread, a side wall, a belt, a carcass and the like of a tire for a passenger car or a large tire for a truck or a bus.

What is claimed is:

1. A rubber composition comprising:
a diene-based rubber;
an anthracene compound having at least one substituent selected from the group consisting of a nitrile oxide group, an azide group, and a thiol group, the anthracene compound being incorporated into the diene-based rubber; and
a crosslinking agent having two or more dienophile structures.

2. The rubber composition according to claim 1, wherein the crosslinking agent is a bismaleimide compound.

3. The rubber composition according to claim 1, wherein the anthracene compound is anthracene-9-carbonitrile oxide.

4. The rubber composition according to claim 2, wherein the anthracene compound is anthracene-9-carbonitrile oxide.

5. A crosslinked rubber obtained by heating the rubber composition according to claim 1.

6. A crosslinked rubber obtained by heating the rubber composition according to claim 2.

7. A crosslinked rubber obtained by heating the rubber composition according to claim 3.

8. A crosslinked rubber obtained by heating the rubber composition according to claim 4.

9. A method for producing a rubber composition, comprising:
a first step of mixing a diene-based rubber with an anthracene compound having at least one substituent selected from the group consisting of a nitrile oxide group, an azide group, and a thiol group;
a second step of mixing the composition obtained in the first step with a reinforcing filler; and
a third step of mixing the composition obtained in the second step with a crosslinking agent having two or more dienophile structures.

10. The production method according to claim 9, wherein the crosslinking agent is a bismaleimide compound.

11. The production method according to claim 9, wherein the anthracene compound is anthracene-9-carbonitrile oxide.

12. The production method according to claim 10, wherein the anthracene compound is anthracene-9-carbonitrile oxide.
